(19) United States
(12) Patent Application Publication
(10) Pub. No.: US 2018/0163030 A1
(43) Pub. Date: Jun. 14, 2018

(54) RUBBER COMPOSITION FOR TIRE TREAD, AND PNEUMATIC TIRE

(71) Applicant: Toyo Tire & Rubber Co., Ltd., Itami-shi (JP)

(72) Inventor: Shinsaku Kamada, Itami-shi (JP)

(73) Assignee: Toyo Tire & Rubber Co., Ltd., Itami-shi (JP)

(21) Appl. No.: 15/823,768

(22) Filed: Nov. 28, 2017

(30) Foreign Application Priority Data
Dec. 9, 2016 (JP) 2016-239587
Dec. 9, 2016 (JP) 2016-239590

(51) Int. Cl. C08L 9/06; B60C 1/00

(52) U.S. Cl. CPC C08L 9/06; C08L 2205/03; C08L 2205/025; B60C 1/0016

(57) ABSTRACT

A rubber composition according to one embodiment contains 100 parts by mass of a diene rubber, from 110 to 150 parts by mass of carbon black having a nitrogen adsorption specific surface area of from 140 to 250 m²/g, and from 5 to 30 parts by mass of syndiotactic-1,2-polybutadiene having a melting point higher than 100° C. A rubber composition according to another embodiment contains 100 parts by mass of a diene rubber, and from 110 to 150 parts by mass of the carbon black, wherein loss factor tan δ and storage modulus E′ (MPa) of a vulcanizate thereof measured at a temperature of 100° C. satisfy 0.050≤tan δ/E′≤0.150. Those rubber compositions are used in a tread rubber of a pneumatic tire.

### CROSS-REFERENCE TO RELATED APPLICATIONS

This application is based upon and claims the benefit of priority from the prior Japanese Patent Applications No. 2016-239587 and 2016-239590, filed on Dec. 9, 2016; the entire contents of which are incorporated herein by reference.

### BACKGROUND

### 1. Field of the Invention

The present invention relates to a rubber composition for a tire tread, and a pneumatic tire using the rubber composition.

### 2. Related Art

High grip performance on a dry road surface is required in a pneumatic tire, particularly a tire for motor sports. Furthermore, a tire for motor sports becomes high temperature state during running, and rigidity of a treat rubber is decreased. As a result, rapid heat generation occurs, leading to the decrease of driving stability and grip performance. For this reason, it is required to suppress rapid heat generation due to the decrease of rigidity in high temperature state and improve the decrease of driving stability and grip performance.

It is conventionally known to add syndiotactic-1,2-polybutadiene (hereinafter referred to as “SPB”) to a rubber composition for a tire. For example, JP-A-07-188461 discloses adding SPB having a melting point of from 120 to 180° C. to a diene rubber together with silica for the purpose of enhancing low rolling resistance and processability without deteriorating wear resistance, fracture resistance and wet grip performance. JP-A-2001-233994 discloses adding a polymer compound having a melting point of from 80 to 230° C. to a diene rubber for the purpose of enhancing ice and snow controlling performance while maintaining wet grip performance, and SPB is exemplified as the polymer compound. JP-A-2009-235191 discloses the addition of modified styrene-butadiene rubber having a functional group and SPB for the purpose of improving processability while maintaining a balance in wear resistance, fracture properties, low heat generation performance and wet grip performance.

However, in a composition having high grip performance on a dry road surface imparted thereto, it was not known to use SPB to suppress the decrease of rigidity in high temperature state thereof.

On the other hand, it is known in a tire tread rubber that a ratio tan δ/E′ between loss factor tan δ and storage modulus E′ is an index of grip performance, and grip performance is enhanced as the ratio is large (JP-A-2005-023146, JP-A-8-132823, JP-A-2009-046088 and JP-A-3-186402).

### SUMMARY

A first embodiment of the present invention has an object to provide a rubber composition for a tire tread that can suppress rapid heat generation due to the decrease of rigidity in high temperature state and can improve the decrease of driving stability and grip performance.

The grip performance of a tire for motor sports has high correlation with tan δ/E′ at 100° C., and it is required to increase this value. On the other hand, when the value is too large, it becomes a factor of blowout. The “blowout” used herein is a phenomenon that volatile substances in compounding ingredients become gaseous by heat generation due to dynamic fatigue of a vulcanized rubber, forming porous state, and eject to the outside.

A second embodiment of the present invention has an object to prove a rubber composition for a tire tread that can improve grip performance while suppressing blowout.

A rubber composition for a tire tread according to the first embodiment comprises 100 parts by mass of a diene rubber, from 110 to 150 parts by mass of carbon black having a nitrogen adsorption specific surface area of from 140 to 250 m²/g, and from 5 to 30 parts by mass of syndiotactic-1,2-polybutadiene having a melting point higher than 100° C.

A rubber composition for a tire tread according to the second embodiment comprises 100 parts by mass of a diene rubber, and from 110 to 150 parts by mass of carbon black having a nitrogen adsorption specific surface area of from 140 to 250 m²/g, wherein loss factor tan δ and storage modulus E′ (MPa) of a vulcanizate measured under the conditions of frequency: 10 Hz, initial strain: 10%, dynamic strain: ±1%, and temperature: 100° C. satisfy 0.050≤tan δ/E′≤0.150.

A pneumatic tire according to the present invention comprises a tread rubber comprising the rubber composition described above.

### DETAILED DESCRIPTION

Elements in the embodiments for carrying out the present invention are described in detail below.

### First Embodiment

The rubber composition according to the first embodiment contains a diene rubber, carbon black having a nitrogen adsorption specific surface area of from 140 to 250 m²/g, and syndiotactic-1,2-polybutadiene having a melting point higher than 100° C. According to the first embodiment, rapid heat generation due to the decrease of rigidity in high temperature state can be suppressed, and the decrease of driving stability and grip performance can be improved.

The diene rubber as a rubber component is not particularly limited. Examples of the diene rubber that can be used include natural rubber (NR), isoprene rubber (IR), butadiene rubber (BR), styrene-butadiene rubber (SBR), styrene-isoprene rubber, butadiene-isoprene rubber, styrene-butadiene-isoprene rubber and nitrile rubber (NBA). Those diene rubbers can be used alone or as mixtures of two or more kinds.

As one embodiment, the diene rubber preferably contains styrene-butadiene rubber. Specifically, the diene rubber may be styrene-butadiene rubber alone or may be a blend of styrene-butadiene rubber and other diene rubber. As an example, it is preferred that 100 parts by mass of the diene rubber comprises from 80 to 100 parts by mass of the styrene-butadiene rubber. The other diene rubber is preferably butadiene rubber and/or natural rubber.

In the present embodiment, carbon black having extremely small particle diameter such that a nitrogen adsorption specific surface area (N₂SA) is from 140 to 250 m²/g is used as the carbon black as reinforcing filler. When the carbon black having small particle diameter is used, heat generation property is enhanced, and grip performance of a tire for motor sports can be improved. Additionally, reinforcing property can be improved. When the nitrogen adsorption specific surface area of the carbon black is 250 m²/g or less, heat generation property can be suppressed from being excessively high. The nitrogen adsorption specific surface area of the carbon black is preferably from 160 to 220 m²/g, and more preferably from 180 to 200 m²/g. In the present specification, the nitrogen adsorption specific surface area is measured according to JIS K6217-2.

The content of the carbon black is from 110 to 150 parts by mass per 100 parts by mass of the diene rubber. When the carbon black having small particle diameter as described above is added in such high filling rate, heat generation property can be increased, and additionally reinforcing property can be improved. When the content of the carbon black is 150 parts by mass or less, the heat generation property can be suppressed from being excessively high. The content of the carbon black is more preferably from 110 to 140 parts by mass per 100 parts by mass of the diene rubber.

Syndiotactic-1,2-polybutadiene (SPB) having a melting point higher than 100° C. is added to the rubber composition according to the first embodiment. When the SPB having high melting point is added, the decrease of rigidity in high temperature state can be suppressed and the decrease of driving stability at high temperature can be improved, in the rubber composition having the carbon black having small particle diameter added thereto in high filling rate. The melting point of SPB is preferably higher than 100° C. and 180° C. or lower, more preferably higher than 100° C. and 150° C. or lower, and still more preferably from 105° C. to 130° C. In the present specification, the melting point is a melting peak temperature of DSC curve measured according to JIS K7121.

SPB having the degree of crystallinity of 25% or more is preferably used as the SPB. When the degree of crystallinity is 25% or more, rigidity improvement effect of the rubber composition can be enhanced. The degree of crystallinity of SPB is preferably from 25 to 50%, and more preferably from 25 to 40%. In the present specification, the degree of crystallinity is a value converted from a density measured by a method of collecting gas over water when a density of 1,2-polybutadiene having the degree of crystallinity of 0% is 0.889 g/cm³, and a density of 1,2-polybutadiene having the degree of crystallinity of 100% is 0.963 g/cm³.

The content of 1,2-vinyl bond in SPB is not particularly limited, but is preferably 70 mol % or more, more preferably 80 mol % or more, and still more preferably 90 mol % or more. In the present specification, the content of 1,2-vinyl bond in SPB is a value obtained by an infrared absorption spectrometry (Morello method).

The content of SPB is preferably from 5 to 30 parts by mass per 100 parts by mass of the diene rubber. When SPB is added in an amount of 5 parts by mass or more, the decrease of rigidity at high temperature can be suppressed. When the SPB is added in an amount of 30 parts by mass or less, heat generation property can be suppressed from being excessively high. The content of SPB is more preferably from 10 to 30 parts by mass. SPB corresponds to a resin having high rigidity, rather than a rubber component, and therefore is not included in the diene rubber.

The rubber composition according to the first embodiment preferably contains oil. Various oils generally added to a rubber composition can be used as the oil. A mineral oil comprising hydrocarbon as a main component is preferably used as the oil. Specifically, it is preferred to use at least one mineral oil selected from the group consisting of paraffin oil, naphthene oil and aroma oil.

The content of the oil is preferably from 1.5 to 10.0 times in mass ratio to the content of SPB, that is, 1.5≤oil/SPB (mass ratio)≤10.0. When the mass ratio is 1.5 times or more, it is possible to hardly cause blowout. When the amount of SPB is secured such that the mass ratio is 10.0 times or less, the effect of suppressing the decrease of rigidity at high temperature can be enhanced. The mass ratio is more preferably from 1.7 to 5.0 times.

The content of the oil per 100 parts by mass of the diene rubber is not particularly limited, but is preferably from 20 to 60 parts by mass, and more preferably from 40 to 55 parts by mass.

The rubber composition according to the first embodiment may contain at least one resin selected from the group consisting of a petroleum resin, a coumarone resin, a terpene resin, a phenol resin and a rosin resin. A resin having a softening point of from 70 to 100° C. is preferably used as the resin. When such a thermoplastic resin that softens at high temperature is added, E′ at high temperature is decreased, and grip performance can be enhanced. The softening point of the resin is more preferably from 80 to 100° C., and still more preferably from 90 to 100° C. In the present specification, the softening point is a value measured by a ring and ball method according to HS K2207.

Examples of the petroleum resin include an aliphatic petroleum resin, an aromatic petroleum resin, and an aliphatic/aromatic copolymer petroleum resin. The aliphatic petroleum resin is a resin obtained by cationically polymerizing an unsaturated monomer such as isoprene or cyclopentadiene that is a petroleum fraction (C5 fraction) corresponding to 4 to 5 carbon atoms (the resin is referred to as C5 petroleum resin), and may be a hydrogenated resin. The aromatic petroleum resin is a resin obtained by cationically polymerizing a monomer such as vinyltoluene, alkylstyrene or indene that is a petroleum fraction (C9 fraction) corresponding to 8 to 10 carbon atoms (the resin is referred to as C9 petroleum resin), and may be a hydrogenated resin. The aliphatic/aromatic copolymer petroleum resin is a resin obtained by copolymerizing the C5 fraction and C9 fraction described above (the resin is referred to as C5/C9 petroleum resin), and may be a hydrogenated resin.

The coumarone resin is a resin comprising coumarone as a main component, and examples thereof include a coumarone resin, a coumarone-indene resin, and a copolymer resin comprising coumarone, indene and styrene as main components.

Examples of the terpene resin include polyterpene and a terpene-phenol resin.

Examples of the phenol resin include a phenol-formalin resin and an alkylphenol-acetylene resin.

Examples of the rosin resin include natural resin rosin, and rosin-modified resin obtained by modifying the natural resin rosin by hydrogenation, disproportionation, dimerization, esterification or the like.

Of those resins, at least one petroleum resin selected from the group consisting of an aliphatic petroleum resin, an aromatic petroleum resin, and an aliphatic/aromatic copolymer petroleum resin is preferably used as the resin.

The content of the resin is not particularly limited, but is preferably from 20 to 60 parts by mass, and more preferably from 40 to 60 parts by mass, per 100 parts by mass of the diene rubber. When the content of the resin is 20 parts by mass or more, heat generation property can be enhanced, and storage modulus E′ can be decreased. When the content of the resin is 60 parts by mass or less, the heat generation property can be suppressed from being excessively increased. Mass ratio between the resin and the oil is not particularly limited. A ratio of the resin content to the oil content (resin/oil) is preferably from 0.5 to 2.0, and more preferably from 0.8 to 1.5.

The rubber composition according to the first embodiment can contain various additives that are generally used in a rubber composition, such as stearic acid, zinc flower, an age resister, a wax, a vulcanizing agent and a vulcanization accelerator, in addition to the above components. Examples of the vulcanizing agent include sulfurs such as powdered sulfur, precipitated sulfur, colloidal sulfur, insoluble sulfur and highly dispersible sulfur. The amount of the vulcanizing agent added is not particularly limited, but is preferably from 0.1 to 8 parts by mass, and more preferably from 0.5 to 5 parts by mass, per 100 parts by mass of the diene rubber.

The rubber composition according to the first embodiment is preferably that a ratio of tan δ/E′ of loss factor tan δ and storage modulus E′ (MPa) of a vulcanizate measured under the conditions of frequency: 10 Hz, initial strain: 10%, dynamic strain: ±1%, and temperature: 100° C. satisfies 0.050≤tan δ/E′≤0.150. When the tan δ at 100° C. is increased, heat generation property is enhanced, and as a result, grip performance is enhanced. However, when E′ is high, followability to a road surface is poor, a ground-contact area between a rubber and a road surface is not sufficient, and as a result, grip performance is deteriorated. For this reason, to enhance grip performance on a dry road surface, it is preferred to increase tan δ/E′. It is particularly preferred to increase tan δ/E′ at 100° C. in a tire for motor sports used under high speed running conditions. On the other hand, when tan δ/E′ is too large, blowout is easy to occur. Therefore, when tan δ/E′ at 100° C. as a property of a vulcanized rubber is set to a range of from 0.050 to 0.150, grip performance can be enhanced while suppressing blowout.

In the first embodiment, tan δ/E′ is preferably from 0.070 to 0.140, and more preferably from 0.100 to 0.140. The respective values of tan δ and E′ are not particularly limited. For example, tan δ is from 0.301 to 0.500, and preferably from 0.366 to 0.453. E′ is from 2.9 to 4.3 MPa, and preferably from 2.9 to 3.7 MPa.

The rubber composition according to the first embodiment can be prepared by kneading the necessary components according to the conventional method using a mixing machine generally used, such as Banbury mixer, a kneader or rolls. Specifically, other additives excluding a vulcanizing agent and a vulcanization accelerator are added to a diene rubber together with carbon black and SPB, followed by mixing, in a first mixing step. A vulcanizing agent and a vulcanization accelerator are then added to the mixture thus obtained, followed by mixing, in a final mixing step. Thus, a rubber composition can be prepared.

### Second Embodiment

A rubber composition according to the second embodiment contains a diene rubber, and carbon black having a nitrogen adsorption specific surface area of from 140 to 250 m²/g, wherein a ratio of tan δ/E′ of loss factor tan δ and storage modulus E′ (MPa) of a vulcanizate measured under the conditions of frequency: 10 Hz, initial strain: 10%, dynamic strain: ±1%, and temperature: 100° C. satisfies 0.050≤tan δ/E′≤0.150. According to the second embodiment, grip performance can be enhanced while suppressing blowout.

In the second embodiment, tan δ/E′ is preferably from 0.070 to 0.130, and more preferably from 0.080 to 0.120. The respective values of tan δ and E′ are not particularly limited. For example, tan δ is from 0.250 to 0.750, and preferably from 0.350 to 0.450. E′ is from 3.0 to 7.0 MPa, and preferably from 3.0 to 5.0 MPa.

In the second embodiment, the details and addition amount of the diene rubber as a rubber component and the details and addition amount of carbon black as a reinforcing filler are the same as in the first embodiment described above, and the explanations thereof are omitted.

The rubber composition according to the second embodiment preferably contains oil. Various oils generally added to a rubber composition can be used as the oil. Mineral oil comprising hydrocarbon as a main component is preferably used as the oil. Specifically, at least one mineral oil selected from the group consisting of paraffin oil, naphthene oil and aroma oil is preferably used as the oil.

The content of the oil is preferably from 20 to 60 parts by mass per 100 parts by mass of the diene rubber. When the content of the oil is 20 parts by mass or more, heat generation property can be enhanced, and E′ can be decreased. When the content of the oil is 60 parts by mass or less, the heat generation property can be suppressed from being excessively high. The content of the oil is preferably from 30 to 50 parts by mass.

The rubber composition according to the second embodiment can contain a resin. A resin having a softening point of from 70 to 120° C. is preferably used as the resin. When such a thermoplastic resin that softens at high temperature is added, E′ at high temperature is decreased, and grip performance can be enhanced. The softening point of the resin is more preferably from 80 to 110° C., and still more preferably from 90 to 100° C.

Examples of the resin include a petroleum resin, a coumarone rein, a terpene resin, a phenol resin and a rosin resin. Those resins may be used alone or as mixtures of two or more kinds. The details of those petroleum resin, coumarone rein, terpene resin, phenol resin and rosin resin are the same as described in the first embodiment. At least one petroleum resin selected from the group consisting of an aliphatic petroleum resin, an aromatic petroleum resin, and an aliphatic/aromatic copolymer petroleum resin is preferably used as the resin.

The content of the resin is preferably from 20 to 60 parts by mass, per 100 parts by mass of the diene rubber. When the content of the resin is 20 parts by mass or more, heat generation property can be enhanced, and E′ can be decreased. When the content of the resin is 60 parts by mass or less, the heat generation property can be suppressed from being excessively high. The content of the resin is more preferably from 40 to 60 parts by mass.

Mass ratio between the resin and the oil is not particularly limited. A ratio of the content of the resin to the content of the oil (resin/oil) is preferably from 0.5 to 2.0, and more preferably from 0.8 to 2.0.

The rubber composition according to the second embodiment can contain various additives that are generally used in a rubber composition, such as stearic acid, zinc flower, an age resister, a wax, a vulcanizing agent and a vulcanization accelerator, in addition to the above components. Examples of the vulcanizing agent include sulfurs such as powdered sulfur, precipitated sulfur, colloidal sulfur, insoluble sulfur and highly dispersible sulfur. The amount of the vulcanizing agent added is not particularly limited, but is preferably from 0.1 to 8 parts by mass, and more preferably from 0.5 to 5 parts by mass, per 100 parts by mass of the diene rubber.

The rubber composition according to the second embodiment can be prepared by kneading the necessary components according to the conventional method using a mixing machine generally used, such as Banbury mixer, a kneader or rolls. Specifically, other additives excluding a vulcanizing agent and a vulcanization accelerator are added to a diene rubber together with carbon black, oil and a resin, followed by mixing, in a first mixing step. A vulcanizing agent and a vulcanization accelerator are then added to the mixture thus obtained, followed by mixing, in a final mixing step. Thus, a rubber composition can be prepared.

### Pneumatic Tire

The rubber compositions according to the above embodiments are used in a tread rubber constituting a ground-contact area of a pneumatic tire. The rubber composition is preferably used in a tread rubber of a tire for motor sports. A tread rubber of a pneumatic tire includes a tread rubber comprising a two layer structure of a cap rubber and a base rubber, and a treat rubber comprising an integrated single layer structure of those. The rubber composition is preferably used in a rubber constituting a ground-contact area. Specifically, in the case of a single layer structure, the tread rubber preferably comprises the rubber composition, and in the case of a two layer structure, the cap rubber preferably comprises the rubber composition.

A method for manufacturing a pneumatic tire is not particularly limited. For example, the pneumatic tire can be manufactured by molding the rubber composition into a given shape by extrusion processing according to the conventional method to prepare an unvulcanized tread rubber member, combining the tread rubber member with other members to manufacture an unvulcanized tire (green tire), and then vulcanization molding the unvulcanized tire at a temperature of, for example, from 140 to 180° C.

### EXAMPLES

### Test 1

Banbury mixer was used. Other compounding ingredients excluding sulfur and a vulcanization accelerator were added to a diene rubber according to the formulations (parts by mass) shown in Table 1 below, followed by kneading, in a first mixing step (discharge temperature: 160° C.). Sulfur and a vulcanization accelerator were then added to the kneaded material obtained, followed by kneading, in a final mixing step (discharge temperature: 90° C.). Thus, rubber compositions (Compositions C1 to C12) were prepared. The amount of oil was changed such that hardness at room temperature of a vulcanized rubber is almost constant.

The details of each component in Table 1 are as follows.

SBA: “JSR0202” manufactured by JSR Corporation

Carbon black 1: “DIABLACK N339” (N₂SA: 91 m²/g) manufactured by Mitsubishi Chemical Corporation

Carbon black 2: “DIABLACK-UX10” (N₂SA: 190 m²/g) manufactured by Mitsubishi Chemical Corporation

Carbon black 3: “SEAST 9” ((N₂SA: 142 m²/g) manufactured by Tokai Carbon Co., Ltd.

SPB-1: Syndiotactic-1,2-polybutadiene having melting point of 71° C., 1,2-vinyl bond content of 90 mol % and the degree of crystallinity of 18%, “RB810” manufactured by JSR Corporation

SPB-2: Syndiotactic-1,2-polybutadiene having melting point of 105° C., 1,2-vinyl bond content of 93 mol % and the degree of crystallinity of 29%, “RB830” manufactured by JSR Corporation

SPB-3: Syndiotactic-1,2-polybutadiene having melting point of 126° C., 1,2-vinyl bond content of 94 mol % and the degree of crystallinity of 36%, “RB840” manufactured by JSR Corporation

Petroleum resin: Aliphatic petroleum resin, “QUITONE M100” (softening point: 95° C.) manufactured by Zeon Corporation

Oil: Aroma type, “PROCESS NC140” manufactured by JX Nippon Oil & Sun Energy Corporation

Stearic acid: “LUNAC 5-20” manufactured by Kao Corporation

Zinc flower: “Zinc Flower #1” manufactured by Mitsui Mining & Smelting Co., Ltd.

Age resister: “ANTIGEN 6C” manufactured by Sumitomo Chemical Co., Ltd.

Wax: “OZOACE 0355” manufactured by Nippon Seiro Co., Ltd.

Vulcanization accelerator: “SOXINOL CZ” manufactured by Sumitomo Chemical Co., Ltd.

Sulfur: “POWDERED SULFUR” manufactured by Tsurumi Chemical Industry Co., Ltd.

A test piece (width: 5.0 mm, length: 20 mm and thickness 1.0 mm) was obtained by vulcanizing each of Compositions C1 to C12 at 160° C. for 30 minutes. Tan δ and E′ of each test piece thus obtained were measured, and a ratio tan δ/E′ of those was obtained. A test piece of No. 3 Dumbbell specimen was prepared by vulcanizing at 160° C. for 30 minutes, and its rigidity at high temperature was measured. Each of Compositions C1 to C12 was used in a tread rubber, and vulcanization molded according to the conventional method to manufacture a tire for motor sports (tire size: 31/71-18). Movement performance (lap time) and blowout performance (1) of the tire obtained were measured. Each measurement method is described below.

Tan δ: Tan δ was measured under the conditions (extension deformation) of frequency: 10 Hz, initial strain: 10%, dynamic strain: ±1% and temperature: 100° C. using a viscoelasticity tester manufactured by Toyo Seiki Seisaku-Sho, Ltd. according to JIS K6394.

E′: E′ was measured under the conditions (extension deformation) of frequency: 10 Hz, initial strain: 10%, dynamic strain: ±1% and temperature: 100° C. using a viscoelasticity tester manufactured by Toyo Seiki Seisaku-Sho, Ltd. according to JIS K6394.

Rigidity at high temperature: Modulus at 100% elongation (100% tensile stress: S100) was measured under the condition of 100° C. using an automatic tensile tester manufactured by Ueshima Seisakusho Co., Ltd. according to HS K6251. The rigidity at high temperature was indicated by an index as the value of Composition C1 being 100. S100 is high, that is, the rigidity at high temperature is high, as the index is large.

Movement performance (lap time): Four tires were mounted on an actual vehicle (racing vehicle), and lap time of closed circuit (1 lap: 3.5 km) by driving with a professional driver was measured. An average time of 40 laps was obtained. An inverse number of the average time was indicated by an index as a value obtained in a tire manufactured using Composition C1 being 100. The lap time is fast as the index is large, and the movement performance is excellent.

Blowout performance (1): Blowout generated in a tread was visually measured in conjunction with the measurement of lap time. In case where blowout was confirmed after completion of the lap time measurement test, it is indicated as “B”, and in, case where blowout was not confirmed, it is indicated as “A”.

The results obtained are shown in Table 1 below.

TABLE 1

| | Composition | | | | | | | | | | | |
|---|---|---|---|---|---|---|---|---|---|---|---|---|
| | C1 | C2 | C3 | C4 | C5 | C6 | C7 | C8 | C9 | C10 | C11 | C12 |
| Formulation | | | | | | | | | | | | |
| (parts by mass) | | | | | | | | | | | | |
| SBR | 100 | 100 | 100 | 100 | 100 | 100 | 100 | 100 | 100 | 100 | 100 | 100 |
| Carbon black 1 | — | 120 | — | — | — | — | — | — | — | — | — | — |
| Carbon black 2 | 120 | — | 120 | 120 | 120 | 120 | 120 | 120 | 110 | 140 | 120 | — |
| Carbon black 3 | — | — | — | — | — | — | — | — | — | — | — | 120 |
| SPB-1 | — | — | 10 | — | — | — | — | — | — | — | — | — |
| SPB-2 | — | 10 | — | 3 | 40 | 30 | 10 | 5 | 10 | 10 | — | 10 |
| SPB-3 | — | — | — | — | — | — | — | — | — | — | 10 | — |
| Petroleum resin | 45 | 45 | 45 | 45 | 45 | 45 | 45 | 45 | 45 | 45 | 45 | 45 |
| Oil | 45 | 45 | 45 | 45 | 61 | 55 | 49 | 47 | 35 | 25 | 49 | 49 |
| Stearic acid | 2 | 2 | 2 | 2 | 2 | 2 | 2 | 2 | 2 | 2 | 2 | 2 |
| Zinc flower | 3 | 3 | 3 | 3 | 3 | 3 | 3 | 3 | 3 | 3 | 3 | 3 |
| Age resister | 2 | 2 | 2 | 2 | 2 | 2 | 2 | 2 | 2 | 2 | 2 | 2 |
| Wax | 2 | 2 | 2 | 2 | 2 | 2 | 2 | 2 | 2 | 2 | 2 | 2 |
| Vulcanization | 2 | 2 | 2 | 2 | 2 | 2 | 2 | 2 | 2 | 2 | 2 | 2 |
| accelerator | | | | | | | | | | | | |
| Sulfur | 2 | 2 | 2 | 2 | 2 | 2 | 2 | 2 | 2 | 2 | 2 | 2 |
| Oil/SPB | — | 4.5 | 4.5 | 15.0 | 1.5 | 1.8 | 4.9 | 9.4 | 3.5 | 2.5 | 4.9 | 4.9 |
| Property and | | | | | | | | | | | | |
| evaluation | | | | | | | | | | | | |
| Tan δ | 0.359 | 0.181 | 0.371 | 0.363 | 0.484 | 0.438 | 0.410 | 0.394 | 0.426 | 0.392 | 0.488 | 0.316 |
| E′ (MPa) | 3.9 | 3.7 | 3.6 | 3.9 | 3.1 | 3.2 | 3.8 | 3.9 | 3.2 | 4.0 | 3.9 | 3.9 |
| Tan δ/E′ | 0.092 | 0.049 | 0.103 | 0.093 | 0.156 | 0.137 | 0.108 | 0.101 | 0.133 | 0.098 | 0.125 | 0.081 |
| Rigidity at high | 100 | 125 | 83 | 98 | 117 | 111 | 108 | 104 | 105 | 110 | 109 | 118 |
| temperature | | | | | | | | | | | | |
| Movement | 100 | 93 | 95 | 100 | 91 | 107 | 106 | 104 | 107 | 103 | 107 | 101 |
| performance | | | | | | | | | | | | |
| (lap time) | | | | | | | | | | | | |
| Blowout | A | A | B | A | B | A | A | A | A | A | A | A |
| performance (1) | | | | | | | | | | | | |

Composition C1 is that carbon black having small particle diameter was added in high filling rate. Grip performance represented by tan δ/E′ was high, and lap time was fast in the actual vehicle. However, the lap time was slow due to the decrease of driving stability and grip performance in laps of the last stage. As a result, the total lap time was slow, and movement performance was poor.

Composition C2 is a composition obtained by adding SPB having high melting point to Composition C1. As a result, rigidity at high temperature was high, and driving stability at high temperature was excellent. However, carbon black does not have small particle diameter. Therefore, sufficient heat generation property was not obtained (tan δ/E′ was small). As a result, lap time by an actual vehicle was slow, and movement performance was poor.

Composition C3 is a composition obtained by adding SPB having low melting point to Composition C1. Sufficient heat generation property was obtained, but rigidity at high temperature is low. As a result, in the measurement of lap time by an actual vehicle, driving stability and grip performance were decreased in laps of the last stage. As a result, the lap time was slow, and movement performance was poor.

In Composition C5, the amount of SPB added is too large, and therefore, the amount of oil is increased. As a result, heat generation property is too high, and in the measurement of lap time by an actual vehicle, driving stability and grip performance were decreased in laps of the last stage. As a result, the lap time was slow, and blowout was generated.

On the other hand, Compositions C6 to C12 according to the first embodiment are obtained by adding SPB having high melting point to compositions having carbon black having small particle diameter added thereto in high filling rate. This can increase rigidity at high temperature while maintaining tan δ/E′ in a predetermined range. The balance between heat generation property at high temperature and driving stability was good. Furthermore, in the measurement of lap time by an actual vehicle, rapid heat generation due to the decrease of rigidity could be suppressed, and driving stability and grip performance could be maintained. As a result, delay of lap time in laps of the last stage was suppressed, thereby showing excellent movement performance.

### Test 2

Banbury mixer was used. Other compounding ingredients excluding sulfur and a vulcanization accelerator were added to a diene rubber according to the formulations (parts by mass) shown in Table 2 below, followed by kneading, in a first mixing step (discharge temperature: 160° C.). Sulfur and a vulcanization accelerator were then added to the kneaded material obtained, followed by kneading, in a final mixing step (discharge temperature: 90° C.). Thus, rubber compositions (Compositions C21 to C32) were prepared.

The details of each component in Table 2 are as follows. However, the same components as in the components in Table 1 are described before.

Resin 1: Aliphatic petroleum oil, “QUINTONE M100” (softening point: 95° C.) manufactured by Zeon Corporation.

Resin 2: Phenol-formalin thermoplastic resin, “DUREZ 19900” (softening point: 95° C.) manufactured by Sumitomo Bakelite Co., Ltd.

A test piece (width: 5.0 mm, length: 20 mm and thickness 1.0 mm) was obtained by vulcanizing each of Compositions C21 to C32 at 160° C. for 30 minutes. Tan δ and E′ of each test piece were measured. Each of Compositions C21 to C32 was used in a tread rubber, and vulcanization molded according to the conventional method to manufacture a tire for motor sports (tire size: 31/71-18). Grip performance and blowout performance (2) of the tire obtained were measured. Each measurement method is described below.

Tan δ and E′: Same as in Test 1

Grip performance (measurement of lap time): Four tires were mounted on an actual vehicle (racing vehicle), and lap time of closed circuit (1 lap: 3.5 km) by driving with a professional driver was measured. An average time of 10 laps was obtained. An inverse number of the average time was indicated by an index as a value obtained in a tire manufactured using Composition C21 being 100. The lap time is fast as the index is large, and the grip performance is excellent. Test 2 differs from Test 1 in the running number of laps.

Blowout performance (2): Blowout generated in a tread was visually evaluated in conjunction with the measurement of lap time. In case where blowout was confirmed after completion of the lap time measurement test, it is indicated as “B”, and in, case where blowout was not confirmed, it is indicated as “A”. Test 2 differs from Test 1 in the running number of laps.

The results obtained are shown in Table 2 below.

TABLE 2

| | Composition | | | | | | | | | | | |
|---|---|---|---|---|---|---|---|---|---|---|---|---|
| | C21 | C22 | C23 | C24 | C25 | C26 | C27 | C28 | C29 | C30 | C31 | C32 |
| Formulation | | | | | | | | | | | | |
| (parts by mass) | | | | | | | | | | | | |
| SBR | 100 | 100 | 100 | 100 | 100 | 100 | 100 | 100 | 100 | 100 | 100 | 100 |
| Carbon black 1 | — | — | — | 120 | — | — | — | — | — | — | — | — |
| Carbon black 2 | 90 | 120 | 120 | — | 120 | 120 | 120 | 120 | 110 | 140 | 120 | — |
| Carbon black 3 | — | — | — | — | — | — | — | — | — | — | — | 120 |
| Resin 1 | 20 | 80 | 10 | 45 | 45 | 30 | 60 | 35 | 45 | 45 | — | 45 |
| Resin 2 | — | — | — | — | — | — | — | — | — | — | 45 | — |
| Oil | 60 | 10 | 80 | 45 | 45 | 60 | 30 | 35 | 35 | 25 | 45 | 45 |
| Stearic acid | 2 | 2 | 2 | 2 | 2 | 2 | 2 | 2 | 2 | 2 | 2 | 2 |
| Zinc flower | 3 | 3 | 3 | 3 | 3 | 3 | 3 | 3 | 3 | 3 | 3 | 3 |
| Age resister | 2 | 2 | 2 | 2 | 2 | 2 | 2 | 2 | 2 | 2 | 2 | 2 |
| Wax | 2 | 2 | 2 | 2 | 2 | 2 | 2 | 2 | 2 | 2 | 2 | 2 |
| Vulcanization | 2 | 2 | 2 | 2 | 2 | 2 | 2 | 2 | 2 | 2 | 2 | 2 |
| accelerator | | | | | | | | | | | | |
| Sulfur | 2 | 2 | 2 | 2 | 2 | 2 | 2 | 2 | 2 | 2 | 2 | 2 |
| Property and | | | | | | | | | | | | |
| evaluation | | | | | | | | | | | | |
| Tan δ | 0.180 | 0.534 | 0.230 | 0.133 | 0.363 | 0.354 | 0.407 | 0.314 | 0.386 | 0.336 | 0.343 | 0.264 |
| E′ (MPa) | 3.9 | 3.5 | 5.6 | 3.8 | 3.9 | 4.6 | 3.8 | 5.7 | 3.3 | 4.1 | 3.9 | 4.0 |
| Tan δ/E′ | 0.046 | 0.153 | 0.041 | 0.035 | 0.092 | 0.077 | 0.107 | 0.055 | 0.117 | 0.082 | 0.088 | 0.067 |
| Grip | 100 | 109 | 99 | 94 | 106 | 104 | 108 | 101 | 110 | 105 | 106 | 102 |
| performance | | | | | | | | | | | | |
| Blowout | A | B | A | A | A | A | A | A | A | A | A | A |
| performance (2) | | | | | | | | | | | | |

Composition C21 is a composition having added thereto carbon black having a particle diameter smaller than that of the conventional general carbon black. However, the addition amount as small, and as a result, tan δ/E′ was small, and grip performance was not sufficient. Composition C22 is a composition in which the addition amount of carbon black having small particle diameter was increased and the amount of a resin was increased in Composition C21. Tan δ/E′ was too large, and blowout was generated. In Composition C23, the amount of the resin was excessively decreased, and as a result, tan δ/E′ was decreased, and grip performance was deteriorated. Composition C24 is the case that a large amount of carbon black having general particle diameter was added. In such a case, tan δ/E′ was small, and grip performance was poor.

On the other hand, in Compositions C25 to C32 according to the second embodiment, a large amount of carbon black having small particle diameter was added and the amounts of the resin and oil added were adjusted, thereby setting tan δ/E′ to the predetermined range. As a result, grip performance as a tire for motor sports could be enhanced while suppressing blowout.

Some embodiments of the present invention are described above, but those embodiments are described as examples, and are not intended to limit the scope of the invention. Those embodiments can be carried out in various embodiments, and various omissions, replacements and changes can be made in a range that does not deviate from the gist of the invention. The omission, replacement, change and the like are included in the scope and gist of the invention, and are also included in the inventions described in the claims and their equivalent ranges.

What is claimed is:

1. A rubber composition for a tire tread comprising 100 parts by mass of a diene rubber, from 110 to 150 parts by mass of carbon black having a nitrogen adsorption specific surface area of from 140 to 250 m²/g, and from 5 to 30 parts by mass of syndiotactic-1,2-polybutadiene having a melting point higher than 100° C.

2. The rubber composition for a tire tread according to claim 1, wherein the syndiotactic-1,2-polybutadiene has the degree of crystallinity of 25% or more.

3. The rubber composition for a tire tread according to claim 1, wherein loss factor tan δ and storage modulus E′ (MPa) of a vulcanizate thereof measured under the conditions of frequency: 10 Hz, initial strain: 10%, dynamic strain: ±1%, and temperature: 100° C. satisfy 0.050≤tan δ/E′≤0.150.

4. The rubber composition for a tire tread according to claim 1, further comprising oil, wherein the content of the oil is from 1.5 to 10.0 times in mass ratio to the content of the syndiotactic-1,2-polybutadiene.

5. The rubber composition for a tire tread according to claim 1, further comprising at least one resin selected from the group consisting of a petroleum resin, a coumarone resin, a terpene resin, a phenol resin and a rosin resin.

6. The rubber composition for a tire tread according to claim 5, wherein the resin has a softening point of from 70 to 100° C.

7. A pneumatic tire comprising a tread rubber comprising the rubber composition according to claim 1.

8. The pneumatic tire according to claim 7, which is a tire for motor sports.

9. A rubber composition for a tire tread comprising 100 parts by mass of a diene rubber, and from 110 to 150 parts by mass of carbon black having a nitrogen adsorption specific surface area of from 140 to 250 m²/g,
wherein loss factor tan δ and storage modulus E′ (MPa) of a vulcanizate thereof measured under the conditions of frequency: 10 Hz, initial strain: 10%, dynamic strain: ±1%, and temperature: 100° C. satisfy 0.050≤tan δ/E′≤0.150.

10. The rubber composition for a tire tread according to claim 9, further comprising oil in an amount of from 20 to 60 parts by mass per 100 parts by mass of the diene rubber.

11. The rubber composition for a tire tread according to claim 9, further comprising a resin in an amount of from 20 to 60 parts by mass per 100 parts by mass of the diene rubber.

12. The rubber composition for a tire tread according to claim 11, wherein the resin has a softening point of from 70 to 120° C.

13. The rubber composition for a tire tread according to claim 11, wherein the resin is at least one selected from the group consisting of a petroleum resin, a coumarone resin, a terpene resin, a phenol resin and a rosin resin.

14. A pneumatic tire comprising a tread rubber comprising the rubber composition according to claim 9.

15. The pneumatic tire according to claim 14, which is a tire for motor sports.
